(19) United States
(12) Patent Application Publication
(10) Pub. No.: US 2022/0004886 A1
(43) Pub. Date: Jan. 6, 2022

(54) METHODS FOR CONTROLLING AND UPDATING A PROCESSING SCHEME OF AN ELECTRONIC DEVICE, RELATED SERVER DEVICES AND RELATED ELECTRONIC DEVICES

(71) Applicant: Sony Corporation, Tokyo (JP)

(72) Inventors: Peter EXNER, Malmö (SE); Jim RASMUSSON, Lund (SE); Olivier MOLINER, Lund (SE)

(21) Appl. No.: 17/278,308

(22) PCT Filed: Dec. 18, 2019
(86) PCT No.: PCT/SE2019/051306

§ 371 Date: Mar. 21, 2021

(30) Foreign Application Priority Data
Jan. 25, 2019 (SE) 1950091-7

(51) Int. Cl. G06N 5/02; G06F 16/28; H04L 29/06

(52) U.S. Cl. CPC G06N 5/022; H04L 67/42; G06F 16/285

(57) ABSTRACT

A method (100) is disclosed, the method (100) being performed by a server device, where the server device (400) is configured to communicate with a first electronic device (300) of a plurality of electronic devices (300, 300A-300I), the first electronic device being configured to operate using a processing scheme based on a machine-learning model. The method (100) comprises receiving (S102), from the first electronic device (300), an update request for updating the machine-learning model, the update request comprising sensor data indicative of a context surrounding the first electronic device (300); generating (S107) an updated machine-learning model based on the sensor data of the update request; and transmitting (S110) an update response comprising the updated machine-learning model to the first electronic device (300).

The present disclosure relates to management and control of electronic devices, such as Internet of Things (IoT) devices. In particular, the present disclosure relates to method, performed by a server device, where the server device is configured to communicate with a first electronic device configured to operate using a processing scheme based on a machine-learning model, methods performed by an electronic device, and server device, and related electronic devices.

### BACKGROUND

The use of Internet of Things (IoT) devices is increasing. It is envisaged that control of the IoT devices may be based on machine-learning models. One concern about using IoT devices is that many IoT devices have constrained resources in terms of memory, and battery. Additionally, another concern is that to operate and exploit fully an IoT device, its control should preferably be specialized for the environment in which the IoT device is operating in.

In case, a generalized model is deployed regardless of the environment, the data gathered by the IoT device may be misleading or resulting in sub-optimal exploitation.

Therefore, there is a need for controlling an IoT device or electronic device which is configured to operate using a processing scheme based on a machine-learning model to achieve improved performance in various and varying environments.

### SUMMARY

Accordingly, there is a need for methods for controlling electronic devices and updating a processing scheme of electronic devices based on a machine-learning model, which mitigates, alleviates or address the shortcomings existing and provide an improved performance in various and varying environments in which the electronic device is operating in, and where updates of the machine-learning model for electronic devices (e.g. IoT devices) are selectively based on sensor data collected by the electronic devices.

A method performed by a server device is disclosed. The server device is configured to communicate with a first electronic device of a plurality of electronic devices. The first electronic device is configured to operate using a processing scheme based on a machine-learning model. The method comprises receiving from the first electronic device, an update request for updating the machine-learning model, the update request comprising sensor data indicative of a context surrounding the first electronic device. The method comprises generating an updated machine-learning model based on the sensor data of the update request. The method comprises transmitting an update response comprising the updated machine-learning model to the first electronic device.

Further, a server device is provided, the server device comprising an interface module, a memory module, and a processor module. The server device is configured to perform any of the methods disclosed herein.

The present disclosure provides a computer readable storage medium storing one or more programs, the one or more programs comprising instructions, which when executed by a server device cause the server device to perform any of the methods disclosed herein.

It is an advantage of the present disclosure that updates of the machine-learning model are triggered based on sensor data from the “ground” where the electronic devices are placed (such as upon requests including sensor data). This leads to having only the relevant electronic devices (electronic devices that need an update) receive an updated machine-learning model. This results in optimizing the power consumption of the electronic devices and the network traffic between the electronic devices and the server device.

Further, a method is disclosed, where the method is performed by an electronic device. The electronic device is configured to operate using a processing scheme based on a machine-learning model. The method comprises obtaining sensor data indicative of a context surrounding the electronic device. The method comprises determining whether the sensor data satisfies a criterion. The method comprises, when the sensor data does not satisfy the criterion, transmitting to a server device an update request for updating the machine-learning model, the update request comprising the sensor data.

Further, an electronic device is provided, the electronic device comprising: an interface module, a memory module, and a processor module. The electronic device is configured to perform any of the methods disclosed herein.

The present disclosure provides a computer readable storage medium storing one or more programs, the one or more programs comprising instructions, which when executed by an electronic device cause the electronic device to perform any of the methods disclosed herein.

It is an advantage of the present disclosure that the electronic devices become more efficient and more robust in the environment they are performing, as the electronic devices receive from the server device machine-learning model updates to fit the current environment (or the latest reported sensor data for the environment). Further, since updates are only sent and received when the sensor data does not satisfy a criterion, the network traffic between the electronic devices and the server device are optimized.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1A is a diagram illustrating an exemplary system comprising exemplary electronic devices and an exemplary server device according to this disclosure,

FIG. 1B is a diagram illustrating an exemplary system comprising exemplary electronic devices, grouped in a plurality of clusters, and an exemplary server device according to this disclosure,

FIG. 2 is a flow-chart illustrating an exemplary method, performed by a server device, according to this disclosure,

FIG. 3 is a flow-chart illustrating an exemplary method, performed by an electronic device, wherein the electronic device is configured to performed by a processing scheme based on a machine-learning model according to this disclosure,

FIG. 4 is a block diagram illustrating an exemplary electronic device according to this disclosure,

FIG. 5 is a block diagram illustrating an exemplary server device according to this disclosure, and

FIG. 6 is a diagram illustrating an exemplary system comprising exemplary electronic devices, grouped in a plurality of clusters, and an exemplary server device according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

It is envisaged that control of the IoT devices may be based on machine-learning models. One concern about using IoT devices is that many IoT devices have constrained resources and can therefore only store machine-learning models of a fixed size. Ideally, the machine-learning model should therefore be specialized for the environment in which the device is operating. In case, a generalized model is deployed regardless of the environment in which it is operating, there is a need for continuous adaptation to the environment, such as retraining or updating.

Another concern about using IoT devices is how the machine-learning models can be updated and distributed to several thousands of IoT devices that operate in different environments. Many devices are battery-operated and communication costs are significant both in terms of power and network usage. Therefore, updates of the machine-learning model to all IoT devices should be avoided and instead be selective based on the type of data they encounter.

Advantageously, when working with electronic devices, such as IoT devices, electronic devices are deployed that continuously sense data and apply a machine-learning model on the sensed data to perform some task. As more data is collected, the inventors have realized that by updating the machine-learning module according to this disclosure, the electronic devices become more robust to variations in their environment and that the electronic devices are capable of adapting to their environment by continuously adapting (e.g. training) and updating the machine-learning model on which its processing scheme is based on.

For example, electronic devices, such as IoT devices, may be deployed on farms that can identify different types of crops, e.g. sugar beets. Depending on factors such as geographical location, climate, and time aspects, soil types vary and may be exposed to a variety of pests and diseases, etc. Accordingly, the electronic devices disclosed herein are capable of adapting their processing to the environment (soil types, crops, etc.).

For example, for autonomous vehicles, deployment in different climate regions, e.g. desert vs. forest, requires the machine-learning models to operate r function in different backgrounds and encounter different objects. Depending on factors, such as geographical location, climate, and time aspects, vegetation, ground, roads and buildings vary in appearance and present an adaptation challenge to machine-learning tasks, such as image segmentation. Accordingly, the electronic devices disclosed herein are capable of adapting their processing to region.

For example, electronic devices may be integrated in the healthcare sector. For example, if the electronic devices are used as healthcare applications, the electronic devices are capable of processing data based on specialized models e.g. depending on patients, or patients' types.

The electronic device disclosed herein is configured to operate on data using a processing scheme based on a machine-learning model, which machine-learning model is provided and adapted to local environment in which the electronic device is operated.

In one or more exemplary embodiments, the adaptation of the machine-learning model can be done before deployment during a training phase. However, it is difficult (e.g. if not impossible) to anticipate and capture all possible variations in an environment when training the initial machine-learning model.

Accordingly, the present disclosure allows to adapt the processing of the electronic device by updating at a server device the underlying machine-learning model based on sensor data provided by the electronic device.

The figures are schematic and simplified for clarity, and they merely show details which are essential to the understanding of the invention, while other details have been left out. Throughout, the same reference numerals are used for identical or corresponding parts.

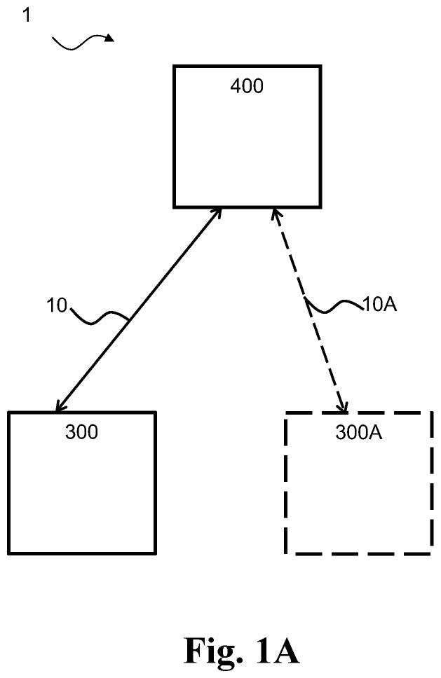

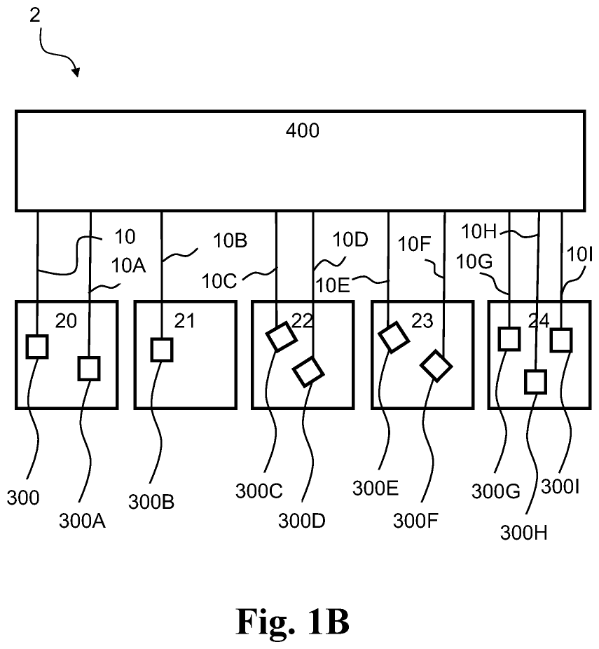

FIG. 1A is a diagram illustrating an exemplary system 1 comprising exemplary electronic devices 300, 300A and an exemplary server device 400 according to this disclosure.

As discussed in detail herein, the present disclosure relates to a system 1 comprising an exemplary server device 400 and exemplary electronic devices 300, 300A.

For example, system 1 of FIG. 1A comprises a first electronic device 300 and a second electronic device 300A.

An electronic device comprises an IoT device, and/or a sensor device and/or an actuator device, and/or an appliance device, and/or a vehicular device.

The electronic device 300, 300A and the server device 400 may be configured to communicate with each other via a wireless link (or radio access link) 10, 10A. The electronic device 300, 300A may be configured to receive data, such as updated machine-learning models from the server device. The electronic device 300, 300A may be configured to send data, such as sensor data to the server device 400.

The server device 400 may comprise a cloud-based server device.

A machine-learning model may comprise a data structure or data set comprising data elements and their relations, that enable to perform prediction and/or decisions, such as regression, classification and/or clustering. For example, the machine-learning model may comprise a set of input data and may predict a set of output data. Examples of machine-learning models include an artificial neural network comprising a set of nodes, logistic regression and/or one or more decision trees.

FIG. 1B is a diagram illustrating an exemplary system 2.

System 2 comprises exemplary electronic devices 300, 300A-300I, grouped in a plurality of clusters.

System 2 comprises an exemplary server device 400 according to this disclosure.

The electronic device 300, 300A-300I and the server device 400 may be configured to communicate with each other via wireless links (or radio access links) 10, 10A-10I.

In FIG. 1B, the electronic devices 300, 300A-300I are distributed in five different environments 20-24. A first electronic 300 and a second electronic device 300A are located in a first environment 20.

A third electronic device 300B is located in a second environment 21. A fourth electronic device 300C and a fifth electronic device 300D are located in a third environment 22. A sixth electronic device 300E and a seventh electronic device 300F are located in a fourth environment 23. An eighth electronic device 300G, a ninth 300H and a tenth electronic device 300I are located in a fifth environment 24.

Each of the electronic devices 300, 300A-300I is configured to obtain sensor data indicative of a context of the environment 20-24 surrounding the respective electronic device 300, 300A-300I. For example, the first electronic 300 may be configured to provide to the server device 400 sensor data indicative of a context of the first environment 20.

Further, the electronic device 300, 300A-300I may be configured to send sensor data in sensor data signal(s) to the server device 400 via respective wireless link 10, 10A-10I. The sensor data may be carried in an update request for updating the machine-learning model of any of the respective electronic device 300, 300A-300I.

Thus, the server device 400 may be configured to send a signal, e.g. comprising an updated machine-learning model, via one or more of the wireless links 10, 10A-10I to one or more of the electronic devices 300, 300A-300I in one or more of the environments 20-24. For example, a need to update the machine learning model is triggered on the electronic device 300. One example of a trigger is when the electronic device by applying its machine-learning model on sensed sensor data reaches a confidence score that falls below a threshold. The sensor data, e.g. an image or a sample of the audio, is sent to the server device 400. The server device 400 is configured to access to or store a plurality of machine-learning models, e.g. corresponding to the electronic devices 300, 300A-300I, e.g. paired with previously received sensor data and possibly training data used to create the machine-learning models.

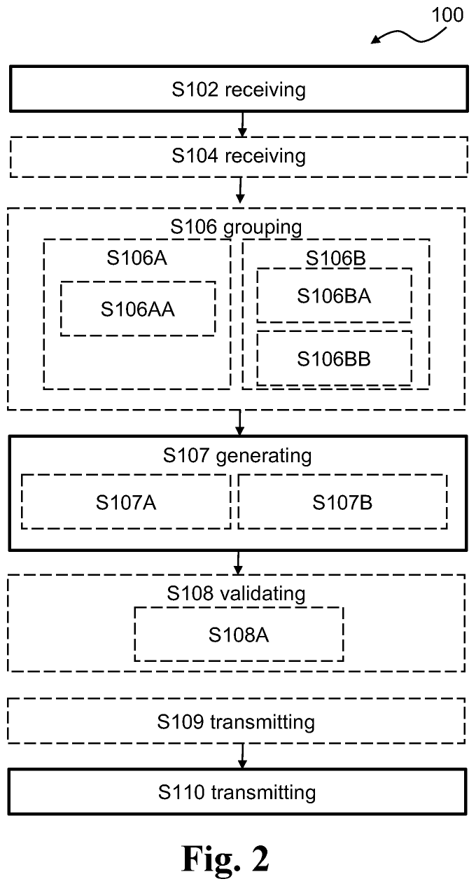

FIG. 2 is a flow-chart illustrating an exemplary method 100, performed by an exemplary server device. The server device is configured to communicate with a first electronic device of a plurality of electronic devices (e.g. the electronic devices disclosed herein, e.g. the first electronic device 300, electronic devices 300A-300I as shown in FIGS. 1A, 1B, 4, 5, 6). The first electronic device is configured to operate using a processing scheme based on a machine-learning model according to this disclosure.

The method 100 is performed by a server device (such as the server device disclosed herein, such as server device 400 illustrated in FIGS. 1A-1B, 5-6).

The first electronic device is configured to operate using a processing scheme based on a machine-learning model. For example, the first electronic device is configured to monitor the environment surrounding the first electronic device, such as to monitor a space surrounding the first electronic device, such as to monitor items in a space monitoring plants, such as to monitor plants or crops in a field, such as to monitor one or more health appliances, such as to monitor one or more physiological levels of patients, such as to monitor one or more vehicles and one or more road equipments, such as to detect one or more vehicles and people in vicinity.

The method 100 comprises receiving S102, from the first electronic device, an update request for updating the machine-learning model. The update request comprises sensor data indicative of a context surrounding the first electronic device. A context surrounding the first electronic device may refer to the environmental conditions, such as the temperature, moisture content, pressure, light condition in the environment (such as environment 20-24 of FIG. 1A) and may comprise the structural elements surrounding the first electronic device 300 and/or the geographical location of the first electronic device. Sensor data may comprise context data. In other words, the sensor data, e.g. image data (e.g. an image) and/or audio data (e.g. a sample of audio) is sent to a server device (e.g. a cloud-based server device, or a fog-based server device).

The method 100 comprises generating S107 an updated machine-learning model based on the sensor data of the update request. For example, generating S107 the updated machine-learning model comprises updating the machine-learning model used by the first electronic device. A machine-learning model may comprise a data structure or data set comprising data elements that enable to perform prediction and/or decisions, such as regression, classification and clustering. For example, the machine-learning model may comprise a set of input data and may predict a set of output data. Examples of machine-learning models include an artificial neural network comprising a set of nodes, logistic regression and one or more decision trees.

The method 100 comprises transmitting S110 an update response comprising the updated machine-learning model to the first electronic device.

This may advantageously lead to the electronic device being configured to optimally operate (e.g. specialized for operating) in its current context. Further, the electronic device increases in robustness in the present environment. Since only the electronic devices that need updating of their machine-learning model are to receive an updated machine-learning model, the power consumption of the electronic devices and the network traffic are lowered.

In one or more exemplary methods, the method 100 comprises receiving S104 sensor data from one or more electronic devices 300A-300I of the plurality of electronic devices 300, 300A-300I (such as from one or more electronic devices 300A-300I in addition to the first electronic device 300).

In one or more exemplary methods, the method 100 comprises grouping S106, into a plurality of clusters, the plurality of electronic devices based on sensor data received from the plurality of electronic devices. For example, a plurality may comprise two or more, such as five, ten, twenty or more.

A cluster may refer to a group of electronic devices, such as IoT devices, which are located in the same and/or similar type of context and/or environment. Thus, a cluster of electronic devices may comprise one or more of electronic devices 300, 300A-300I from one or several environments 20-24. Thus, the updated machine-learning model may be equally suited for the electronic devices part of the same cluster.

In one or more exemplary methods, grouping S106, into the plurality of clusters, the plurality of electronic devices based on the sensor data received from the plurality of electronic devices comprises determining S106A one or more clustering features based on the sensor data.

In one or more exemplary methods, grouping S106, into the plurality of clusters, the plurality of electronic devices based on the sensor data received from the plurality of electronic devices comprises applying S106B a clustering scheme on the clustering features. A clustering scheme may refer to vector analysis of vector (e.g. of the clustering features, e.g. features in images, or features of location), which may be used to group.

In one or more exemplary methods, determining S106A one or more clustering features based on the sensor data comprises extracting S106AA one or more features based on the sensor data. For example, the one or more features may comprise geometric and/or structural features, such as a distance between coordinates and one or more shapes of objects. For example, when the electronic devices are operated and/or deployed on a farm or field of crops, the one or more features may relate to leaves and/or fruits of different types of crops, and/or cattle. For example, extracting S106AA one or more features based on the sensor data may comprise extracting one or more feature from image data e.g. by using an auto-encoder. An auto-encoder is an encoder configured to extract visible features, e.g. thorns on the plant, and hierarchy of features, from the image data. For example, the auto-encoder may be fed with image data, e.g. images of e.g. plants (such as groups of sugar beets) and may generate a vector indicating the features present in the plants. An advantage of applying an auto-encoder may be that it automatically adapts to the sensor data as it is received without manual supervision. An alternative traditional image processing technique, scale-invariant feature transform (SIFT), may be used to characterize objects. However, for SIFT, manual decisions are required.

In one or more exemplary methods, applying S106B the clustering scheme on the clustering features comprises applying S106BA a clustering scheme on the extracted one or more features, locations of the plurality of electronic devices 300, 300A-300I, and/or temporally filtered data. Temporally filtered data may refer to sensor data recorded within a time window. For example, when the electronic devices 300, 300A-300I are operated/deployed on a farm, temporally filtered data may be used to detect and/or control outbreak of an affliction (disease, pest, etc.) by clustering sensor data regarding the plants on the farm in a time frame preceding the initial outbreak. Thereby, other clusters of plants at risk of being affected may be identified.

In other words, for example, the server device is configured to group electronic devices using a clustering algorithm, e.g. DBScan, applied on one or more of: the one or more features extracted from the sensor data received from one or more electronic devices, including sensor data that triggered the update (e.g. sensor data of the update request), locations of the electronic devices which may be part of the sensor data, and temporally filtered data. For example, for extraction, an autoencoder can be used to extract features from image data of the sensor data.

In one or more exemplary methods, generating S107 the updated machine-learning model based on the sensor data of the update request comprises generating S107A the updated machine-learning model based on the sensor data of the update request, and on the sensor data received from electronic devices in the same cluster as the first electronic device 300. An updated machine-learning model updated accordingly increases adaptability of machine-learning model to the relevant electronic devices (e.g. electronic devices experiencing similar conditions, and thereby benefiting from the updated machine-learning model are part of the same cluster).

In one or more exemplary methods, the method 100 comprises transmitting S109 the updated machine-learning model to the electronic devices in the same cluster as the first electronic device 300. For example, the server device may distribute the new or updated machine-learning model to the electronic devices in the same cluster as the first electronic device.

In one or more exemplary methods, generating S107 the updated machine-learning model based on the sensor data of the update request comprises training S107B the machine-learning model based on the sensor data. For example, sensor data from electronic devices in the same cluster as the first electronic device that triggered the update request may be used by the server device for training a new machine-learning model.

In one or more exemplary methods, the extracted features comprise geometric features. Geometric features may refer to spatial features characterizing a geometry of one or more items or of the context in the environment of the electronic device.

Geometric features may refer to spatial and/or structural elements of items in the environment in which the electronic devices are located/deployed/operated. For example, when the electronic devices are operated/deployed on a farm, the electronic devices may be configured to obtain sensor data, e.g. comprising image data indicative of plants and/or crops comprising leaves, fruits and the geometric feature may comprise geometric features of the plants and/or crops (e.g. polygonal shapes).

In one or more exemplary methods, applying S106B the clustering scheme on the one or more clustering features comprises applying 106BB a density-based spatial clustering of applications with noise. For example, applying S106B the clustering scheme on the one or more clustering features from image data (e.g. geometric features (e.g. of leaves indicative of e.g. plants), or human (eyes)) may be done by performing a density-based spatial clustering of applications with noise (DBScan). DBScan may refer to a density-based clustering algorithm: given a set of points in space, DBScan groups together points that are closely packed together (points with many nearby neighbours), marking as outliers points that lie alone in low-density regions (whose nearest neighbours are further away). For example, the DBScan may be applied on distances between vectors (L1 norm, L2 norm) of features in the image data. For example, the DBScan may apply the largest weight to the location distance and features distances.

In one or more exemplary methods, the sensor data comprises environmental data, accelerometer data and/or media data, wherein media data comprises image data and/or audio data and/or video data. In one or more exemplary methods, when the sensor data comprises image data, extracting features based on the sensor data may comprise applying an autoencoder for extracting features from the images.

For example, image data may comprise digital image data or analogue image data. Image data may comprise one or more images.

For example, environmental data may comprise one or more of: temperature data, moisture level data, pressure data. For example, media data may comprise one or more of: text data, image data, graphic object data (including drawings, sketches and illustrations), animation sequence data, audio data and video data.

In one or more exemplary methods, the method 100 further comprises validating S108 the updated machine-learning model based on sensor data received from the electronic devices in the same cluster as the first electronic device 300.

In one or more exemplary methods, validating S108 the updated machine-learning model based on sensor data received from the electronic devices in the same cluster as the first electronic device 300 may comprise validating S108 prior to transmitting the updated machine-learning model (e.g. in step S110).

For example, sensor data (e.g. raw data) for updating the machine-learning model may comprise newly sensed data from the electronic devices in the same cluster. Labels indicating that the machine-learning model may be validated (e.g. to establish a ground truth) may be generated from either an inference decision from a more capable cloud-based machine-learning model or from a human domain expert (which goes on the domain/terrain to report observations/annotation). This may be seen as establishing a ground truth.

Validating S108 the updated machine-learning model based on sensor data received from the electronic devices in the same cluster as the first electronic device 300 may comprise applying the updated machine-learning model to the sensor data received to obtain updated output and determining a confidence score based on the updated output and the updated machine-learning model. For example, a confidence score for an inference decision may be obtained using the updated output and the updated machine-learning model. For classification models, confidence scores may be estimates of the class probability. When the confidence score falls below a certain threshold, the updated machine learning model does not satisfy the criterion. Validating S108 the updated machine-learning model based on sensor data received from the electronic devices in the same cluster as the first electronic device 300 may comprise determining whether the updated output and the updated machine-learning model satisfies the criterion comprises determining whether the confidence score satisfies a precision criterion.

In one or more exemplary methods, validating S108 the updated machine-learning model based on sensor data received from the electronic devices in the same cluster as the first electronic device 300 comprises determining S108A an inference decision from a cloud-based machine-learning model.

In one or more exemplary methods, a cloud-based machine-learning model may comprise a more complex model run on a server device. For example, for the electronic devices, the machine-learning model may be simplified. In a cloud-based server, the machine-learning model may be more complex, as the cloud-based server may have a higher number of nodes in its neural network than in the neural network of an electronic device, especially IoT device.

It may be envisaged that the server device is configured to maintain two machine-learning models: a complex machine-learning model (e.g. a deep convolutional network for object recognition, e.g. VGG, and/or Inception) to be used in the server device 400 and a simple machine-learning model (e.g. MobileNets) for distribution to the electronic devices (e.g. an updated simple machine-learning model for IoT device).

For example, the server device may be configured to derive a simple machine-learning model from a complex machine-learning model by compactization of the complex machine-learning model in order to transform the complex machine-learning model to a simple machine-learning model (which may be done by reducing dimensionality of the complex machine-learning model, and/or by reducing precision of parts or all of the parameters in the machine-learning model, e.g. float32 to int8 or float16).

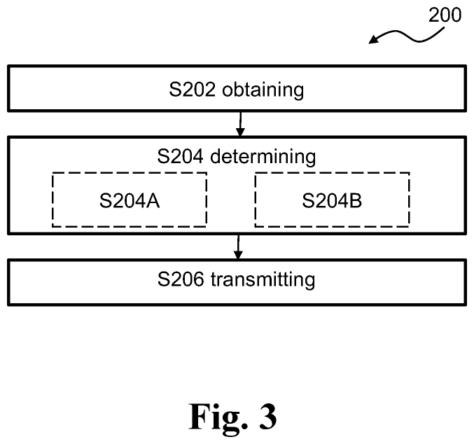

FIG. 3 is a flow-chart illustrating an exemplary method 200, performed by an electronic device. The electronic device disclosed herein (e.g. electronic device 300, 300A-300I of FIG. 1A-B) is configured to operate using a processing scheme based on a machine-learning model according to this disclosure.

The method 200 is performed by an electronic device. An electronic device may for example comprise an IoT device, such as an autonomous vehicle.

In one or more exemplary methods, the method 200 comprises obtaining S202 sensor data indicative of a context surrounding the electronic device (e.g. indicative of an environment surrounding the electronic device). Obtaining S202 sensor data may comprise collecting sensor data (e.g. via one or more sensors of the electronic device), receiving sensor data (e.g. from one or more sensors of the electronic device), and/or retrieving sensor data (e.g. from one or more sensors of the electronic device).

In one or more exemplary methods, sensor data may characterize a context surrounding the electronic device and sensor data may thus comprise context data.

In one or more exemplary methods, the method 200 comprises determining S204 whether the sensor data satisfies a criterion. For example, the criterion may comprise a precision criterion. Stated differently, for example, the electronic device by applying the machine-learning model on sensor data may determine that a confidence score falls below a threshold, and thereby does not satisfy the criterion.

In one or more exemplary methods, the method 200 comprises, when the sensor data does not satisfy the criterion, transmitting S206 to a server device 400 an update request for updating the machine-learning model, the update request comprising the sensor data. For example, the criterion may not be satisfied e.g. when a change in the environment (e.g. environment 20-24) is detected, or when the electronic device 300 is relocated to another location, e.g. to another field. The electronic device may be configured to process image data locally and determine a prediction. The criterion may not be satisfied when the precision in operations of the electronic device drops significantly. For example, when the electronic device is located at a farm, the growth of the plants is not as expected, due to e.g. disease or unexpected seasonal change, then the criterion may not be satisfied.

In one or more exemplary methods, determining S204 whether the sensor data satisfies the criterion comprises determining 5204A a confidence score based on the sensor data. For example, a confidence score for an inference decision may be obtained from the machine-learning model on the electronic device, e.g. on the IoT device. For classification models, confidence scores may be estimates of the class probability. When the confidence score falls below a certain threshold, the sensor data does not satisfy the criterion and an update request is triggered. The confidence score may be outputted by the electronic device with the sensor data.

In one or more exemplary methods, determining S204 whether the sensor data satisfies the criterion comprises determining 5204B whether the confidence score satisfies a precision criterion. In one or more exemplary methods, the sensor data does not satisfy the criterion when the confidence score does not satisfy the precision criterion.

In one or more exemplary methods, the sensor data comprises environmental data, accelerometer data and/or media data. In one or more exemplary methods, the sensor data comprises media data comprises image data and/or audio data and/or video data.

In one or more exemplary methods, the sensor data comprises image data.

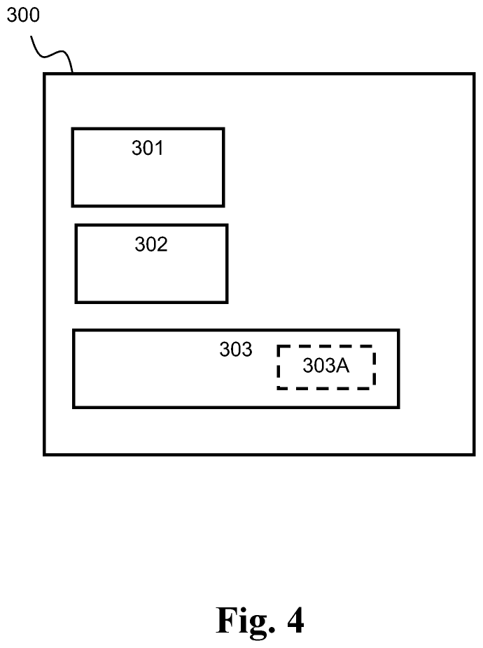

FIG. 4 is a block diagram illustrating an exemplary electronic device 300 according to this disclosure.

The electronic device 300 comprises an interface module 301, a memory module 302, and a processor module 303. The electronic device 300 is configured to operate using a processing scheme based on a machine-learning model.

The electronic device 300 is configured to communicate with a server device, such as the server device disclosed herein, using a wireless communication system.

The interface module 301 is configured for wireless communications via a wireless communication system, such as a 3GPP system, such as a 3GPP system supporting IoT communications. The electronic device 300 is configured to communicate with the server device using wireless communications systems such as cellular systems (e.g. Narrowband IoT, e.g. low cost Narrowband IoT or category M).

The electronic device 300 or the processor module 303 is configured to obtain, via the interface module 301, sensor data indicative of a context surrounding the electronic device 300.

The electronic device 300 or the processor module 303 is configured to determine (optionally via a determiner module 303A) whether the sensor data satisfies a criterion.

The electronic device 300 or the processor module 303 is configured to, when the sensor data does not satisfy the criterion, transmit, via the interface module 301, to a server device an update request for updating the machine-learning model, the update request comprising the sensor data.

In one or more exemplary electronic devices, the electronic device 300 may be configured to perform any of the methods described herein.

The processor module 303 is optionally configured to perform any of the operations disclosed in FIG. 3. The operations of the electronic device 300 may be embodied in the form of executable logic routines (e.g., lines of code, software programs, etc.) that are stored on a non-transitory computer readable medium (e.g., the memory module 302) and are executed by the processor module 303).

Furthermore, the operations of the electronic device 300 may be considered a method that the electronic device is configured to carry out. Also, while the described functions and operations may be implemented in software, such functionality may as well be carried out via dedicated hardware or firmware, or some combination of hardware, firmware and/or software.

The memory module 302 may be one or more of a buffer, a flash memory, a hard drive, a removable media, a volatile memory, a non-volatile memory, a random access memory (RAM), or other suitable device. In a typical arrangement, the memory module 302 may include a non-volatile memory for long term data storage and a volatile memory that functions as system memory for the processor module 303. The memory module 302 may exchange data with the processor module 303 over a data bus. Control lines and an address bus between the memory module 302 and the processor module 303 also may be present (not shown in FIG. 4). The memory module 302 is considered a non-transitory computer readable medium.

The memory module 303 may be configured to store an updated machine-learning model in a part of the memory module 303.

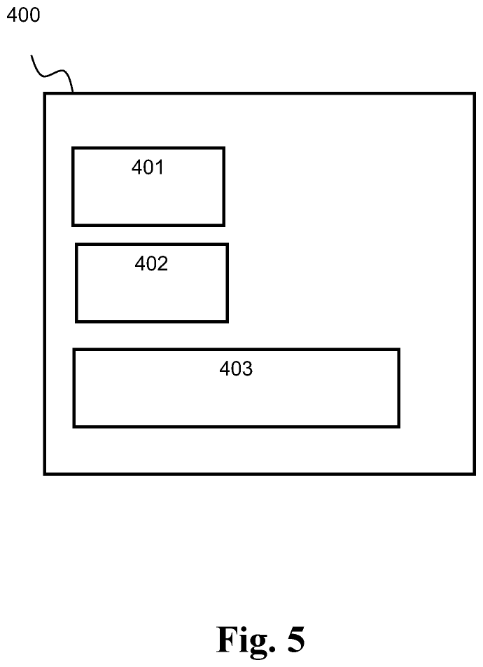

FIG. 5 is a block diagram illustrating an exemplary server device 400 according to this disclosure. The server device 400 comprises an interface module 401, a memory module 402, and a processor module 403. The server device 400 is configured to communicate with a first electronic device of a plurality of electronic devices. The first electronic device is configured to operate using a processing scheme based on a machine-learning model.

The server device 400 is configured to communicate with the first electronic device, such as the first electronic device disclosed herein (e.g. electronic device 300 of FIG. 1A-1B), using a wireless communication system.

The interface module 401 is configured for wireless communications via a wireless communication system, such as a 3GPP system, such as a 3GPP system supporting IoT communications. The server device 400 is configured to communicate with the first electronic device 300 (or any of the plurality of electronic devices 300, 300A-300I) using wireless communications systems such as cellular systems (e.g. Narrowband IoT, e.g. low cost Narrowband IoT or category M).

The server device 400 is configured to receive, from the first electronic device, via the interface module 401, an update request for updating the machine-learning model, the update request comprising sensor data indicative of a context surrounding the first electronic device 300.

The server device 400 or the processor module 403 is configured to generate an updated machine-learning model based on the sensor data of the update request.

The server device 400 is configured to transmit, via the interface module 401, an update response comprising the updated machine-learning model to the first electronic device.

In one or more exemplary server devices, the server device 400 may be configured to perform any of the methods described herein.

The processor module 403 is optionally configured to perform any of the operations disclosed in FIG. 2. The operations of the server device 400 may be embodied in the form of executable logic routines (e.g., lines of code, software programs, etc.) that are stored on a non-transitory computer readable medium (e.g., the memory module 402) and are executed by the processor module 403.

Furthermore, the operations of the server device 400 may be considered a method that the server device 400 is configured to carry out. Also, while the described functions and operations may be implemented in software, such functionality may as well be carried out via dedicated hardware or firmware, or some combination of hardware, firmware and/or software.

The memory module 402 may be one or more of a buffer, a flash memory, a hard drive, a removable media, a volatile memory, a non-volatile memory, a random access memory (RAM), or other suitable device. In a typical arrangement, the memory module 402 may include a non-volatile memory for long term data storage and a volatile memory that functions as system memory for the processor module 403. The memory module 402 may exchange data with the processor module 403 over a data bus. Control lines and an address bus between the memory module 402 and the processor module 403 also may be present (not shown in FIG. 5). The memory module 402 is considered a non-transitory computer readable medium.

The memory module 402 may be configured to store an updated machine-learning model for each of the electronic devices in a part of the memory module 402.

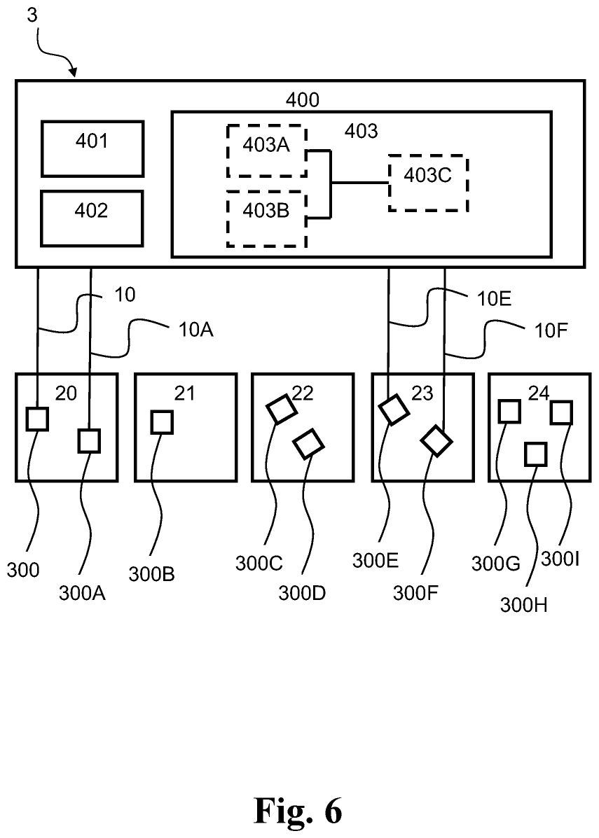

FIG. 6 is a diagram illustrating an exemplary system 3 comprising exemplary electronic devices 300, 300A-300I, grouped in a plurality of clusters, and an exemplary server device 400 according to this disclosure.

The electronic devices 300, 300A-300I may be IoT devices and may in an embodiment be autonomous vehicles.

The electronic device 300, 300A-300I and the server device 400 may be configured to communicate with each other via a wireless link (or radio access link) 10, 10A-10I. The electronic device 300, 300A-300I and the server device 400 may be configured to exchange data.

The electronic devices 300, 300A-300I are distributed in five different environments 20-24. A first electronic 300 and a second electronic device 300A are located in a first environment 20.

A third electronic device 300B is located in a second environment 21. A fourth electronic device 300C and a fifth electronic device 300D are located in a third environment 22. A sixth electronic device 300E and a seventh electronic device 300F are located in a fourth environment 23. An eighth electronic device 300G, a ninth 300H and a tenth electronic device 300I are located in a fifth environment 24.

The electronic device 300, 300A-300I may be configured to obtain sensor data indicative of a context of the corresponding environment 20-24 surrounding the respective electronic device 300, 300A-300I.

Thus, the server device 400 may send an update response comprising an updated machine-learning model, via one or more of the wireless links 10, 10A-10I to one or more of the corresponding electronic devices 300, 300A-300I in one or more of the environments 20-24.

The server device 400 comprises an interface module 401 to receive an update request comprising sensor data, an memory module 402 configured to store sensor data and optionally machine-learning models. a processor module 403 configured to perform operations of FIG. 2. The processor module 403 may be configured to carry out step S108 (optionally S108A) using a validation module 403A.

The processor module 403 may be configured to carry out step S106 (optionally S106A, S106AA, S106B, S106BB, S106BB) using a grouping module 403B.

The processor module 403 may be configured to carry out step S107 (optionally S107A, S107B) using a generator module 403C.

Embodiments of methods and products (server device and electronic device) according to the disclosure are set out in the following items:

1. A method, performed by a server device (400), wherein the server device (400) is configured to communicate with a first electronic device (300) of a plurality of electronic devices (300, 300A-300I), the first electronic device being configured to operate using a processing scheme based on a machine-learning model, the method (100) comprising:
receiving (S102), from the first electronic device (300), an update request for updating the machine-learning model, the update request comprising sensor data indicative of a context surrounding the first electronic device (300);
generating (S107) an updated machine-learning model based on the sensor data of the update request; and
transmitting (S110) an update response comprising the updated machine-learning model to the first electronic device (300).

2. The method according to item 1, the method (100) comprising:
receiving (S104) sensor data from one or more electronic devices (300A-300I) of the plurality of electronic devices (300, 300A-300I); and
grouping (S106), into a plurality of clusters, the plurality of electronic devices (300, 300A-300I) based on sensor data received from the plurality of electronic devices (300, 300A-300I).

3. The method according to item 2, wherein grouping (S106), into the plurality of clusters, the plurality of electronic devices (300, 300A-300I) based on the sensor data received from the plurality of electronic devices (300, 300A-300I) comprises:
determining (S106A) one or more clustering features based on the sensor data; and
applying (S106B) a clustering scheme on the clustering features.

4. The method according to item 3, wherein determining (S106A) the one or more clustering features based on the sensor data comprises extracting (S106AA) one or more features based on the sensor data.

5. The method according to item 4, wherein applying (S106B) the clustering scheme on the one or more clustering features comprises applying (S106BA) a clustering scheme on the extracted one or more features, and/or locations of the plurality of electronic devices (300, 300A-300I), and/or temporally filtered data.

6. The method according to any of items 2-5, wherein generating (S107) the updated machine-learning model based on the sensor data of the update request comprises:
generating (S107A) the updated machine-learning model based on the sensor data of the update request, and on the sensor data received from one or more electronic devices in the same cluster as the first electronic device (300); and wherein the method further comprises transmitting (S109) the updated machine-learning model to the electronic devices in the same cluster as the first electronic device (300).

7. The method according to any of the previous items, wherein generating (S107) the updated machine-learning model based on the sensor data of the update request comprises training (S107B) the machine-learning model based on the sensor data.

8. The method according to item 4, wherein the extracted features comprise geometric features.

9. The method according to any of items 3-8, wherein applying (S106B) the clustering scheme on the clustering features comprises applying (106BB) a density-based spatial clustering of applications with noise.

10. The method according to any of the previous items, wherein the sensor data comprises one or more of: environmental data, accelerometer data and media data, wherein media data comprises one or more of: image data, audio data, and video data.

11. The method according to any of items 6-10, wherein the method (100) further comprises:
validating (S108) the updated machine-learning model based on sensor data received from the electronic devices in the same cluster as the first electronic device (300).

12. The method according to item 11, wherein validating (S108) the updated machine-learning model based on sensor data received from the electronic devices in the same cluster as the first electronic device (300, 300A-300I) comprises:
determining (S108A) an inference decision from a cloud-based machine-learning model.

13. A method, performed by an electronic device (300, 300A-300I), wherein the electronic device (300) is configured to operate using a processing scheme based on a machine-learning model, the method (200) comprising:
obtaining (S202) sensor data indicative of a context surrounding the electronic device (300);
determining (S204) whether the sensor data satisfies a criterion; and
wherein when the sensor data does not satisfy the criterion, transmitting (S206) to a server device (400) an update request for updating the machine-learning model, the update request comprising the sensor data.

14. The method according to item 13, wherein determining (S204) whether the sensor data satisfies the criterion comprises:
determining (5204A) a confidence score based on the sensor data; and
determining (5204B) whether the confidence score satisfies a precision criterion;
   and wherein the sensor data does not satisfy the criterion when the confidence score does not satisfy the precision criterion.

15. The method according to any of the items 13-14, wherein the sensor data comprises environmental data, accelerometer data and/or media data, wherein media data comprises image data and/or audio data and/or video data.

16. A server device (400) comprising an interface (401), a memory module (402), and a processor module (403), wherein the server device (400) is configured to perform any of the methods according to items 1-12.

17. An electronic device (300) comprising an interface (301), a memory module (302), and a processor module (303), wherein the electronic device (300) is configured to perform any of the methods according to items 13-15.

18. A computer readable storage medium storing one or more programs, the one or more programs comprising instructions, which when executed by an electronic device cause the electronic device to perform any of the methods of items 13-15.

19. A computer readable storage medium storing one or more programs, the one or more programs comprising instructions, which when executed by a server device cause the server device to perform any of the methods of items 1-12.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-6 comprises some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications, and equivalents.

1. A method, performed by a server device, wherein the server device is configured to communicate with a first electronic device of a plurality of electronic devices, the first electronic device being configured to operate using a processing scheme based on a machine-learning model, the method comprising:
receiving, from the first electronic device, an update request for updating the machine-learning model, the update request comprising sensor data indicative of a context surrounding the first electronic device;
receiving sensor data from one or more electronic devices of the plurality of electronic devices;
grouping, into a plurality of clusters, the plurality of electronic devices based on sensor data received from the plurality of electronic devices; wherein grouping, into the plurality of clusters, the plurality of electronic devices comprises determining one or more clustering features based on the sensor data; and applying a clustering scheme on the clustering features;
generating an updated machine-learning model based on the sensor data of the update request; and
transmitting an update response comprising the updated machine-learning model to the first electronic device.

2. (canceled)

3. (canceled)

4. The method according to claim 1, wherein determining the one or more clustering features based on the sensor data comprises extracting one or more features based on the sensor data.

5. The method according to claim 4, wherein applying the clustering scheme on the one or more clustering features comprises applying a clustering scheme on the extracted one or more features, and/or locations of the plurality of electronic devices, and/or temporally filtered data.

6. The method according to claim 1, wherein generating the updated machine-learning model based on the sensor data of the update request comprises:
generating the updated machine-learning model based on the sensor data of the update request, and on the sensor data received from one or more electronic devices in the same cluster as the first electronic device; and
wherein the method further comprises transmitting the updated machine-learning model to the electronic devices in the same cluster as the first electronic device.

7. The method according to claim 1, wherein generating the updated machine-learning model based on the sensor data of the update request comprises training the machine-learning model based on the sensor data.

8. The method according to claim 4, wherein the extracted features comprise geometric features.

9. The method according to claim 1, wherein applying the clustering scheme on the clustering features comprises applying a density-based spatial clustering of applications with noise.

10. The method according to claim 1, wherein the sensor data comprises one or more of: environmental data, accelerometer data and media data, wherein media data comprises one or more of: image data, audio data, and video data.

11. The method according to claim 6, wherein the method further comprises:
validating the updated machine-learning model based on sensor data received from the electronic devices in the same cluster as the first electronic device.

12. The method according to claim 11, wherein validating the updated machine-learning model based on sensor data received from the electronic devices in the same cluster as the first electronic device comprises:
determining an inference decision from a cloud-based machine-learning model.

13. A method, performed by an electronic device, wherein the electronic device is configured to operate using a processing scheme based on a machine-learning model, the method comprising:
obtaining sensor data indicative of a context surrounding the electronic device;
determining whether the sensor data satisfies a criterion; and
wherein when the sensor data does not satisfy the criterion, transmitting to a server device an update request for updating the machine-learning model, the update request comprising the sensor data.

14. The method according to claim 13, wherein determining whether the sensor data satisfies the criterion comprises:
determining a confidence score based on the sensor data; and
determining whether the confidence score satisfies a precision criterion;
and wherein the sensor data does not satisfy the criterion when the confidence score does not satisfy the precision criterion.

15. The method according to claim 13, wherein the sensor data comprises environmental data, accelerometer data and/or media data, wherein media data comprises image data and/or audio data and/or video data.

16. A server device comprising an interface a memory module and a processor module, wherein the server device is configured to perform the method of claim 1.

17. An electronic device comprising an interface, a memory module, and a processor module, wherein the electronic device is configured to perform the method of claim 13.

18. A computer readable storage medium storing one or more programs, the one or more programs comprising instructions, which when executed by an electronic device cause the electronic device to perform the method of claim 13.

19. A computer readable storage medium storing one or more programs, the one or more programs comprising instructions, which when executed by a server device cause the server device to perform the method of claim 1.
